(19) United States
(12) Patent Application Publication
(10) Pub. No.: US 2009/0086005 A1
(43) Pub. Date: Apr. 2, 2009

(54) Thermal printer

(76) Inventor: Akihiko Ito, Chiba-shi (JP)

Correspondence Address: BRUCE L. ADAMS, ESQ;ADAMS & WILKS, SUITE 1231, 17 BATTERY PLACE, NEW YORK, NY, 10004, US

(21) Appl. No.: 12/229,807

(22) Filed: Aug. 27, 2008

(30) Foreign Application Priority Data
Sep. 27, 2007 (JP) 2007-251424

(51) Int. Cl. B41J 2/32

(52) U.S. Cl. 347/171

(57) ABSTRACT

In order to simultaneously deal with a plurality of roll sheets each having a different width, achieve increases in functionality and performance, and achieve reduction in cost so as to alleviate a burden on a user, provided is a thermal printer 1 including: a support member 13 for supporting a plurality of roll sheets P each having a different width; conveyor mechanisms 14 each including a conveyor roller 14a for drawing out or drawing back a recording sheet P1 from each of the roll sheets; a guide member for guiding the recording sheet drawn out thereof so as to be converged on a carry-out port; a thermal head including heating elements; a platen roller; a cutting member for cutting the recording sheet; a sensor for detecting whether or not the recording sheet has reached the platen roller; and a control portion 17 for controlling, based on a detection result from the sensor, rotational directions of the conveyor roller and the platen roller so that only a desired recording sheet is sent out from the guide member to a side of the platen roller, and controlling so that printing is performed while activating the heating elements of a number corresponding to a width of the sent-out recording sheet.

### BACKGROUND OF THE INVENTION

1. Field of the Invention

The present invention relates to a thermal printer in which pieces of information of various types are printed on a recording sheet drawn out of a roll sheet.

2. Description of the Related Art

Thermal printers of various types are provided at present in which printing is performed by pressing a heated thermal head against a special recording sheet which undergoes a color change when heat is applied thereto. In particular, the thermal printer is preferably used in printing variety of labels, receipts, and tickets because it is possible to perform the printing of smooth letters and various graphics without using toners, inks, or the like.

A recording sheet used in the printers of various types typified by the thermal printer is normally used while being wound in a roll sheet. The roll sheets of several types each having a different width (for example, 2-inch width, 3-inch width, 4-inch width, and so on) are provided, and used while appropriately selected in accordance with the application.

Incidentally, in the case where the roll sheets each having a different width are used, it is necessary to prepare the thermal printer corresponding to the widths of the roll sheets used. That is, the thermal printer generally has a structure in which printing and cutting are performed only with respect to a sheet of a predetermined size. Thus, it is structurally impossible for a single thermal printer by any means to simultaneously deal with the roll sheets each having a different width. Accordingly, the single thermal printer cannot be used in various manners, for example, in which printing is performed while selectively using, in an appropriate manner, the roll sheets each having a different width in accordance with the printing purpose and the application. By any means, it is inevitable to prepare the thermal printers of the same number as that of the roll sheets each having a different width.

Meanwhile, there has been known an apparatus which can constantly and continuously send out the recording sheet by automatically switching the drawing-out of the recording sheets wound in the two roll sheets as disclosed in patent document JP 04-354749 A.

The apparatus is incorporated in the thermal printer, for example, and constantly sends out the recording sheet to the side of the thermal head. Specifically, there are two roll sheets set in the apparatus, the apparatus being structured so that the recording sheet can be drawn out of each of both the roll sheets. In this case, the apparatus is structured such that the recording sheet is drawn out of the selected one of the roll sheets, instead of simultaneously drawing out the two recording sheets of both the roll sheets, to be sent out to the side of the thermal head. Subsequently, when the signal is received which signifies the running out of the recording sheet drawn out of one of the roll sheets, the switching is automatically performed so that the recording sheet is drawn out of the other roll sheet. During this, the one of the roll sheets is replaced.

As described above, in the printer having the above-mentioned apparatus, two roll sheets can be simultaneously dealt with, and printing can be performed on the recording sheet stably sent thereto even when the operator does not constantly monitor the residual amount of the roll sheets.

However, in the above-mentioned conventional one, although the two roll sheets can be simultaneously dealt with, those two roll sheets have the same width. Therefore, the roll sheets each having a different width cannot be simultaneously dealt with, and consequently, it is inevitable to prepare the thermal printers of the same number as that of the roll sheets each having a different width.

As described above, in the conventional thermal printer, it is necessary to prepare thermal printers dedicated to use of the roll sheet each having a different size, which leads to an increase in cost, so the user bears a large burden. Further, since it is necessary to prepare a plurality of thermal printers, installation spaces therefor are required, which leads to difficulty in dealing therewith.

### SUMMARY OF THE INVENTION

The present invention has been made in view of the above-mentioned circumstances, and an object thereof is to provide a thermal printer which can simultaneously deal with a plurality of roll sheets each having a different width, achieve increases in functionality and performance, and achieve reduction in cost so as to alleviate the burden on the user.

In order to solve the above-mentioned problems, the present invention provides the following means.

A thermal printer according to the present invention, in which a plurality of roll sheets each having a different width and each being obtained by winding a recording sheet into a roll are set, for performing printing on the recording sheet drawn out of the desired roll sheet, is characterized by including:

a support member for rotatably supporting the plurality of roll sheets each having the different width;

conveyor mechanisms disposed in a number corresponding to a number of the plurality of roll sheets and each including a forward-reverse rotatable conveyor roller for drawing out or drawing back the recording sheet wound in each of the roll sheets;

a guide member for guiding the recording sheet drawn out of each of the plurality of roll sheets so as to be converged on a carry-out port;

a thermal head disposed adjacent to the carry-out port of the guide member and including multiple heating elements aligned in a width direction of the recording sheet;

a forward-reverse rotatable platen roller disposed oppositely to the thermal head and having an outer peripheral surface coming into contact with the thermal head in a state where the recording sheet guided by the guide member is sandwiched therebetween;

a cutting member for cutting the recording sheet having passed the thermal head;

a sensor disposed between the guide member and the platen roller, for detecting whether or not the recording sheet guided by the guide member has reached the platen roller; and

a control portion for controlling, based on a detection result from the sensor, rotational directions of the conveyor roller and the platen roller so that only a recording sheet wound in the roll sheet selected from the plurality of roll sheets is sent out from the guide member to a side of the platen roller, and controlling so that printing is performed while activating the heating elements corresponding to a width of the sent-out recording sheet.

In the thermal printer according to the present invention, the plurality of roll sheets each having a different width are rotatably supported by the support member, and the recording sheets each wound in the roll sheet are drawn out to the side of the guide member by the respective dedicated conveyor mechanisms. In this case, the recording sheets each drawn out to the guide member are guided so as to be converged on the carry-out port of the guide member. That is, each of the recording sheets is carried out from one point as much as possible instead of being discretely carried out. Further, any of each of the recording sheets guided to the carry-out port of the guide member is sent to the side of the platen roller, and printing is performed thereon.

That is, the control portion sends out, by rotating only the conveyor roller corresponding to the selected roll sheet, the recording sheet wound in the roll sheet from the carry-out port of the guide member to the side of the platen roller. Then, the sensor detects that the sent-out recording sheet has reached the platen roller, and then provides an output to the control portion. The control portion rotates, by receiving the detection result from the sensor, the platen roller in addition to the conveyor roller. As a result, the recording sheet is sent out while being sandwiched between the outer peripheral surface of the platen roller and the thermal head. Further, simultaneously therewith, the control portion activates the heating elements of the thermal head, the number of which corresponds to the width of the sent-out recording sheet, that is, to the width of the selected roll sheet. As a result, the heating elements corresponding to the width of the recording sheet generate heat, so the letters, figures, or the like of various types can be clearly printed with respect to the sent-out recording sheet. After that, the printed recording sheet is appropriately cut by the cutting member. As a result, the recording sheet wound in the selected roll sheet can be used as a receipt or a ticket.

Next, in the case where printing is performed on the another selected roll sheet having a different width, first, the control portion forward-reverse rotates the conveyor roller and the platen roller so as to draw back the first recording sheet sandwiched between the platen roller and the thermal head. Accordingly, the first recording sheet moves from the side of the platen roller toward the carry-out port of the guide member, and thus is separated from the platen roller. Then, the sensor detects that the recording sheet has been separated from the platen roller, and notifies the control portion. In response thereto, the control portion stops the rotation of the platen roller, and continuously rotates only the conveyor roller for a predetermined time. As a result, the first recording sheet previously subjected to printing can be drawn back from the carry-out port to the inside of the guide member.

Subsequently, the control portion sends out, by rotating only the conveyor roller corresponding to the roll sheet newly selected, the recording sheet wound in the roll sheet from the carry-out port of the guide member to the side of the platen roller. Then, the control portion rotates the platen roller upon reception of the detection result according to which the recording sheet has reached the platen roller. In this manner, the control portion can perform printing with respect to the recording sheet newly selected by performing the control similar to that on the above-mentioned first recording sheet. In this case, the control portion activates the heating elements of the thermal head, the number of which corresponds to the width of the recording sheet newly selected. Accordingly, the letters and figures of various types can be clearly printed over the entire recording sheet having a different width than that of the first recording sheet without involving extra margins or the like.

Further, whenever the new roll sheet is selected again, the control portion repeatedly conducts the above-mentioned operation. As a result, the recording sheets wound in the plurality of roll sheets each having a different width can be simultaneously dealt with, and it is possible to perform printing on the recording sheet of any width without involving extra margins or the like.

In particular, unlike the conventional cases, it is unnecessary to prepare the thermal printers of the same number as that of the roll sheets each having a different width, so large reduction in cost can be achieved, which leads to alleviation of the burden on the user. Further, the installation space therefor can be largely reduced, which leads to the ease with which the thermal printer is dealt with. Further, since the roll sheets each having a different size can be simultaneously used, the functionality as a printer can be increased, thereby achieving increase in performance.

Further, in the above-mentioned thermal printer of the present invention, a thermal printer according to the present invention is characterized in that the support member supports the plurality of roll sheets in a state where the plurality of roll sheets are aligned in a single direction with center lines thereof in a width direction coinciding with one another.

In the thermal printer according to the present invention, since the plurality of roll sheets are aligned in the single direction in the state where the center lines in the width directions coincide with one another, when cutting each of the recording sheets by the cutting member, the recording sheet can be similarly cut from the ends toward the center. Thus, the cutting conditions can be identical to each other, so the quality of the recording sheets after printing can be increased. In particular, since the recording sheet is cut from the ends toward the center, the posture of the recording sheet is less liable to change. Thus, the wrinkles and the like are not generated, so the recording sheet can be cleanly cut. Further, since the plurality of roll sheets can be aligned in a single direction, the compact design can be realized, thereby achieving downsizing.

Further, in the above-mentioned thermal printer of the present invention, a thermal printer according to the present invention is characterized in that the support member supports the plurality of roll sheets in a state where the plurality of roll sheets are disposed at different heights so that the recording sheet to be drawn out of each of the plurality of roll sheets reaches the guide member after being drawn out in a substantially horizontal manner.

In the thermal printer according to the present invention, since each of the recording sheets can be drawn out in a substantially horizontal manner, the recording sheet is less liable to be drawn out and drawn back on its own by the influence of gravity. Thus, by the conveyor roller and the platen roller, taking-out and putting-in of the recording sheets are easily controlled, with the result that the reliability in activation thereof can be further increased.

Further, in the above-mentioned thermal printer of the present invention, a thermal printer according to the present invention is characterized in that the conveyor mechanisms each include a holding plate disposed oppositely to the conveyor roller, for sandwiching, with an aid of the conveyor roller, the recording sheet therebetween.

In the thermal printer according to the present invention, since the recording sheet can be sandwiched between the holding plate and the conveyor roller, the rotation of the conveyor roller can be transmitted to the recording sheet more efficiently. Thus, drawing-out and drawing-back of the recording sheet can be performed more smoothly, so the reliability in activation thereof can be further increased.

Further, in the above-mentioned thermal printer of the present invention, a thermal printer according to the present invention is characterized in that the support member supports, as the plurality of roll sheets, the three roll sheets of 2-inch width, 3-inch width, and 4-inch width.

In the thermal printer according to the present invention, printing can be performed on the recording sheet of each of the roll sheets while selectively using, in an appropriate manner, the three roll sheets of 2-inch width, 3-inch width, and 4-inch width, which are relatively frequently used.

In the thermal printer of the present invention, it is possible to simultaneously deal with a plurality of roll sheets each having a different width, achieve increases in functionality and performance, and achieve reduction in cost so as to alleviate the burden on the user.

### BRIEF DESCRIPTION OF THE DRAWINGS

In the accompanying drawings:

FIG. 1 is an outward appearance perspective view of a thermal printer according to the present invention;

FIG. 2 is a view illustrating an internal structure of the thermal printer illustrated in FIG. 1, that is, a perspective view seen from the direction diagonally forward;

FIG. 3 is a perspective view of the thermal printer illustrated in FIG. 2 seen from the direction diagonally backward;

FIG. 4 is a view of the thermal printer illustrated in FIG. 2 seen from the above;

FIG. 5 is a view of the thermal printer illustrated in FIG. 2 seen from the side;

FIG. 6 is a perspective view of a pedestal plate attached with three conveyor mechanisms constituting the thermal printer illustrated in FIG. 2;

FIG. 7 is a view illustrating a relationship between a conveyor roll of each of the conveyor mechanisms illustrated in FIG. 6 and a recording sheet drawn out of each of the roll sheets;

FIG. 8 is a sectional view of a guide member constituting the thermal printer illustrated in FIG. 2;

FIG. 9 is a perspective view of an attached state of the guide member illustrated in FIG. 8;

FIG. 10 is a sectional view illustrating an internal structure of a printing unit constituting the thermal printer illustrated in FIG. 2;

FIG. 11 is a view illustrating a relationship between a fixed blade and a movable blade constituting the thermal printer illustrated in FIG. 2;

FIG. 12 is a structural block diagram of the thermal printer illustrated in FIG. 2; and

FIG. 13 is a view illustrating a relationship between heating elements of the thermal head which constitute the thermal printer illustrated in FIG. 2 and the width of each of the recording sheets.

### DETAILED DESCRIPTION OF THE PREFERED EMBODIMENT

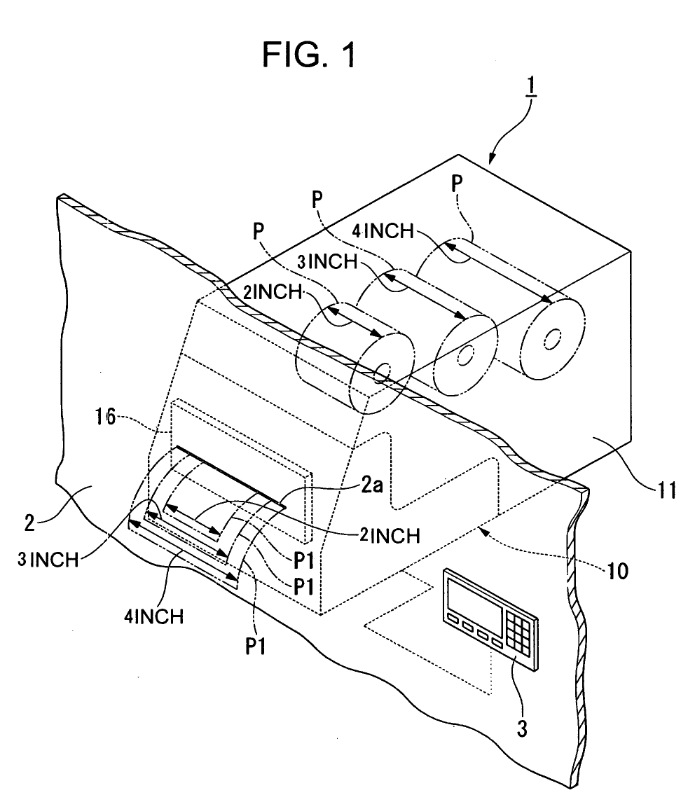

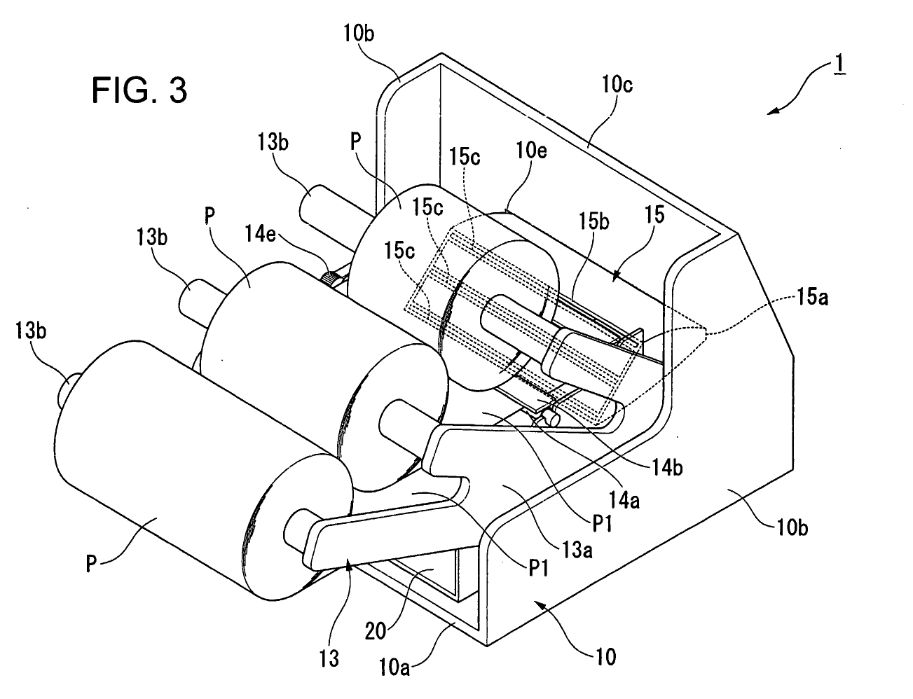

Hereinafter, an embodiment of a thermal printer according to the present invention is described with reference to FIGS. 1 to 13. Note that, in FIGS. 1 to 10, illustrations thereof are abbreviated by appropriate omission of a part of the components, simplification of the configurations, and the like for facilitating the understanding of the invention.

A thermal printer 1 in this embodiment includes, as illustrated in FIG. 1, a plurality of roll sheets P set therein each obtained by winding a recording sheet P1 and each having a different width, and performs printing on a recording sheet P1 drawn out of a desired roll sheet P. Note that, in this embodiment, the thermal printer 1 including three roll sheets of 2-inch width, 3-inch width, and 4-inch width set therein is exemplified.

The thermal printer 1 is used while incorporated, for example, in the account machine installed in an oil feeder in the parking area or self-service gas station, or the ticket-vending machines installed in the various restaurants, and is installed so as to be adjacent to a box body 2 of the account machine or the ticket-vending machine. Then, the recording sheets P1 having widths of three types, which are printed by the thermal printer 1, are discharged through a discharge port 2a, thereby being received by a user.

Further, the thermal printer 1 is activated based on, for example, the instruction input to the operation panel 3 provided on the front surface of the box body 2. In this case, a control portion 17 described later selects any of the roll sheets P of three types in accordance with the instruction input to the operation panel 3, and comprehensively controls each of the components so as to perform printing only on the recording sheet P1 wound in the selected roll sheet P.

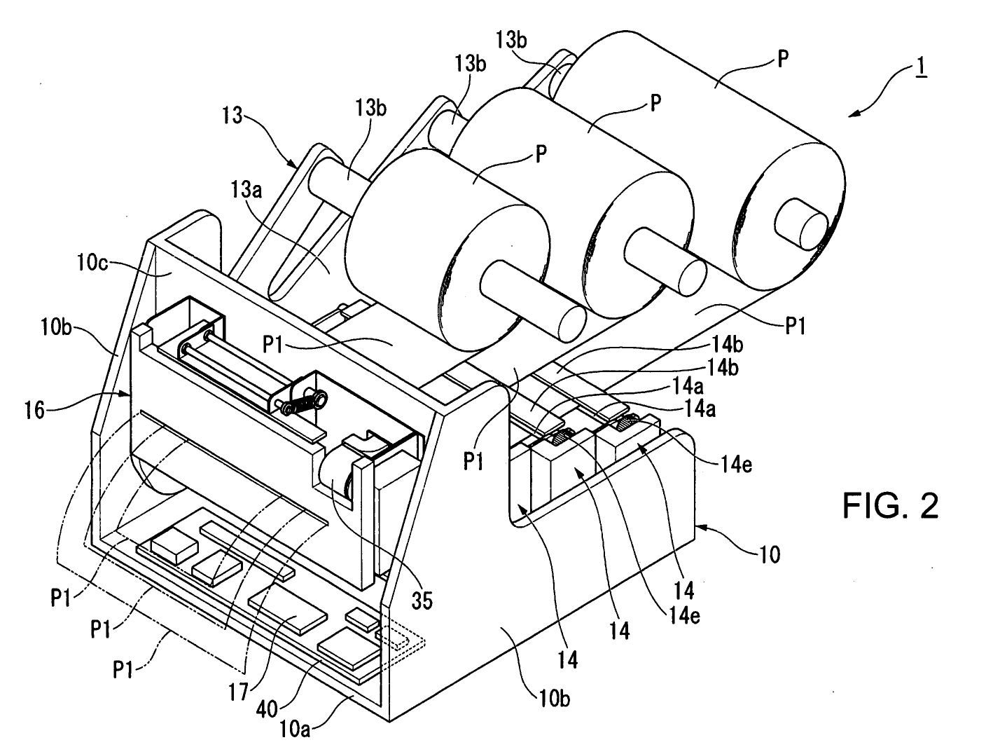

The thermal printer 1 is formed in a box-shaped configuration by a casing 10 and a cover 11 combined with the casing 10. As illustrated in FIGS. 2 to 5, a support member 13, conveyor mechanisms 14, a guide member 15, a printing unit 16, and the control portion 17 are built therein.

The casing 10 is formed of plastic such as polycarbonate or of a metal material such as stainless, and is integrally formed of a bottom portion panel 10a, side panels 10b vertically bent at both sides of the bottom portion panel 10a, and a front panel 10c bridged between the side panels 10b.

The cover 11 is formed of plastic or a metal material similarly to the casing 10, and formed, as illustrated in FIG. 1, so as to exhibit a box-shaped configuration when fitted to the casing 10.

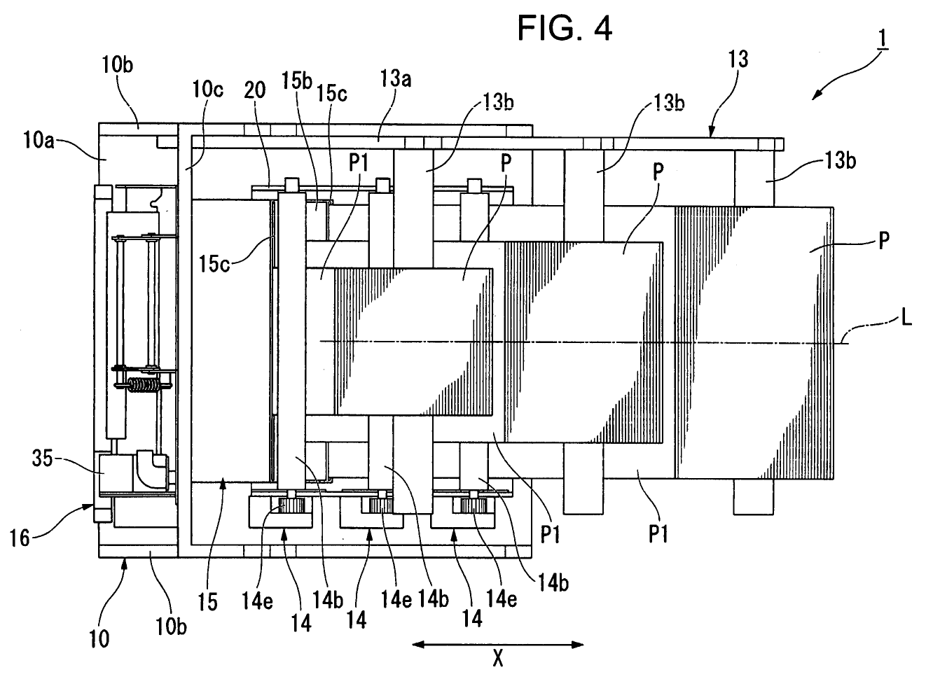

The support member 13 is a member for rotatably supporting the roll sheets P of three types each having a different width, and is constituted by a side plate 13a fixed to one of the side panels 10b of the casing 10, and a three rotational axis portions 13b fixed at each proximal end thereof to the side plate 13a. Each of the three rotational axis portions 13b is a cylindrical bar formed in a size so as to be capable of being inserted into the hollow hole of each of the roll sheets P, and is fixed to, as illustrated in FIG. 4, the side plate 13a in parallel when seen from the above. In this case, when the roll sheets P are inserted from the distal end sides of the rotational axis portions 13b, each of the rotational axis portions 13b is disposed in parallel at predetermined intervals so that the roll sheets P adjacent to each other may not interfere with each other. With this structure, when set to the rotational axis portions 13b, the roll sheets P of three types are supported while aligned in a single direction (X direction illustrated in FIG. 4) in the state where center lines L in the width directions coincide with one another.

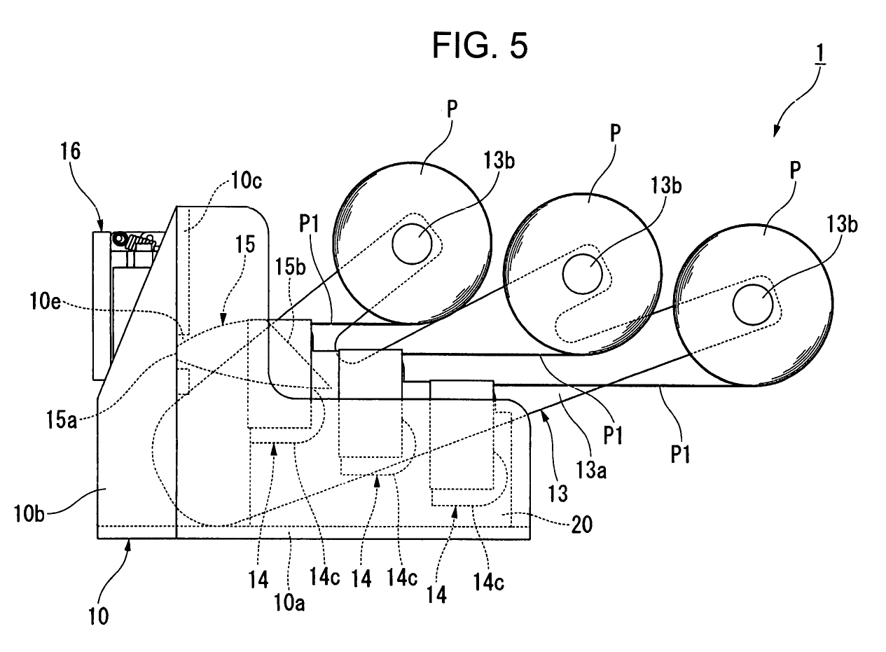

In addition thereto, the three rotational axis portions 13b are fixed, when seen from the side as illustrated in FIG. 5, in the state of being disposed at different heights from one another. Specifically, the three rotational axis portions 13b are fixed so as to gradually reduce the heights thereof as separated from the front panel 10c of the casing 10. With this structure, when the roll sheets P of three types are set to the rotational axis portions 13b, the recording sheet P1 drawn out of each of the roll sheets P is drawn out substantially in a horizontal manner toward the guide member 15.

Note that, in this embodiment, to the rotational axis portions 13b from the side nearer to the front panel 10c, the roll sheets P of 2-inch width, 3-inch width, and 4-inch width are sequentially set.

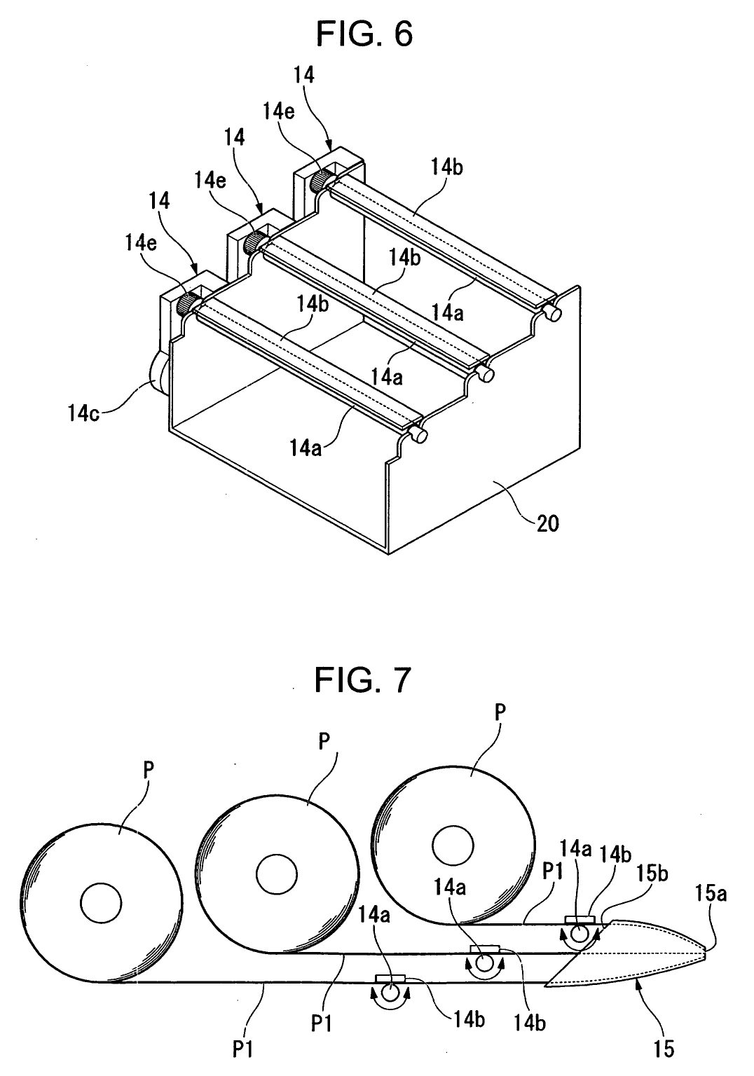

Between each of the roll sheets P set to the three rotational axis portions 13b and the front panel 10c of the casing 10, each of the conveyor mechanisms 14 is attached which has a forward-reverse rotatable conveyor roller 14a for drawing out or drawing back the recording sheet P1 wound in each of the roll sheets P. That is, there are attached three conveyor mechanisms 14 corresponding to the number of the roll sheets P. In a specific description, those three conveyor mechanisms 14 are attached, as illustrated in FIG. 6, to a pedestal frame 20 having a C-shaped cross section fixed to the bottom portion panel 10a of the casing 10.

Each of the conveyor mechanisms 14 is constituted by the conveyor roller 14a disposed in parallel to each of the rotational axis portion 13b so as to cross the pedestal frame 20, a holding plate 14b disposed oppositely to the conveyor roller 14a, for sandwiching the recording sheet P1 of each of the roll sheets P between the conveyor roller 14a, and a motor 14c (stepping motor, for example) for forward-reverse rotating the conveyor roller 14a.

The pedestal frame 20 has an upper portion formed in a stepped configuration so as to be horizontal with respect to each of the three recording sheets P1 drawn out in a substantially horizontal manner, and the conveyor roller 14a is rotatably attached to each of the horizontal positions. The conveyor roller 14a includes a driven gear 14e fixed at one end thereof, the driven gear 14e being engaged with a gear transmission mechanism (not shown) rotated by the motor 14c. With this structure, the conveyor roller 14a is rotated by the rotatably driving force from the motor 14c, and can draw out or draw back the recording sheet P1.

The holding plate 14b is disposed above the conveyor roller 14a in the state of being in contact with the outer peripheral surface of the conveyor roller 14a. Further, the holding plate 14b is fixed to the pedestal frame 20 so as to maintain the state. Further, when passing between the holding plate 14b and the conveyor roller 14a, the recording sheet P1 is, as illustrated in FIG. 7, in a state of being pressed with respect to the side of the conveyor roller 14a by the holding plate 14b.

The motor 14c is activated by receiving the signal from the control portion 17, and rotates the conveyor roller 14a so as to draw out the recording sheet P1 or rotates the conveyor roller 14a in a reverse direction so as to draw back the recording sheet P1.

The guide member 15 is a member for guiding the recording sheet P1 drawn out of each of the roll sheets P of three types so as to converge the recording sheets P1 on a carry-out port 15a thereof, and disposed, as illustrated in FIGS. 2 to 5, between the front panel 10c of the casing 10 and the conveyor mechanism 14 disposed on the side nearer to the front panel 10c.

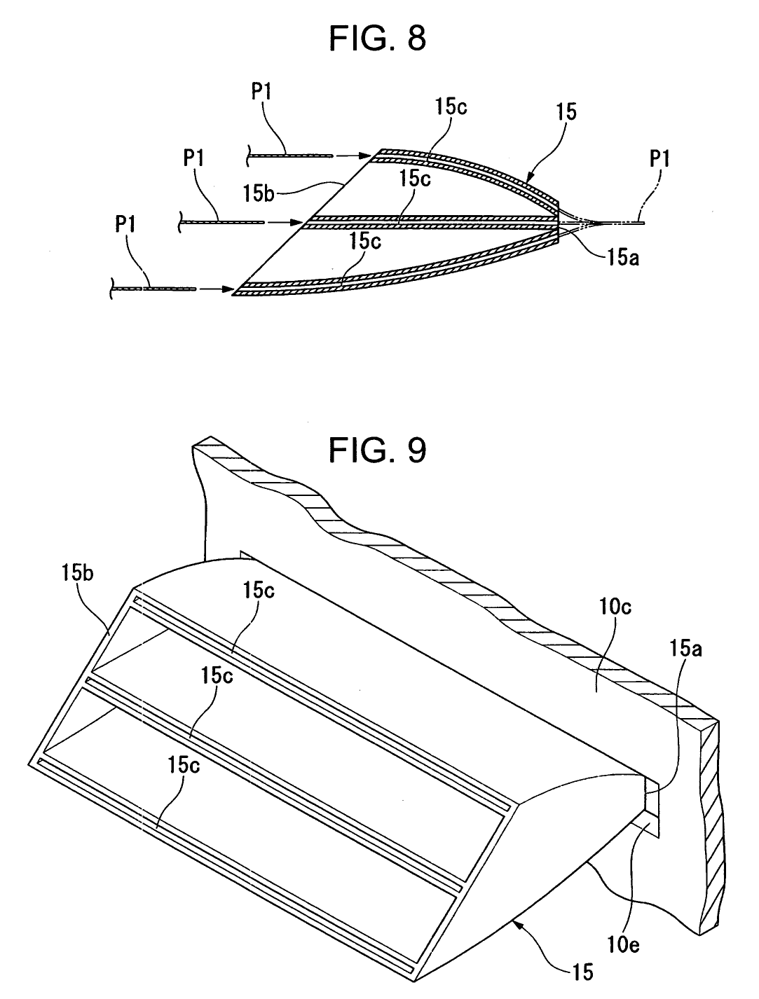

The guide member 15 is injection-molded from plastic or the like, as illustrated in FIG. 7, one end side thereof being a carry-in port 15b and the other end side thereof being the carry-out port 15a through which the recording sheets P1 are carried out. Further, as illustrated in FIGS. 8 and 9, three conveyor paths 15c are formed in an independent state in the guide member 15, each of which communicates from the carry-in port 15b to the carry-out port 15a. The recording sheets P1 enter the conveyor paths 15c from the carry-in port 15b so as to be guided by the conveyor paths 15c to the carry-out port 15a.

Incidentally, the guide member 15 is formed in a curved configuration so as to be smoothly tapered from the carry-in port 15b toward the carry-out port 15a, so the carried-in recording sheets P1 gradually come close to each other toward the carry-out port 15a so as to be converged on one point. That is, since when guided to the carry-out port 15a, the three carried-in recording sheets P1 are guided so as to come as close as possible to each other, the guide member 15 is structured such that the three recording sheets P1 are carried out from the same point.

The guide member 15 structured as described above is fixed at the side of the carry-in port 15b by the pedestal frame 20, and fixed, as illustrated in FIG. 9, in the state where the side of the carry-out port 15a is fitted to an opening portion 10e formed in the front panel 10c.

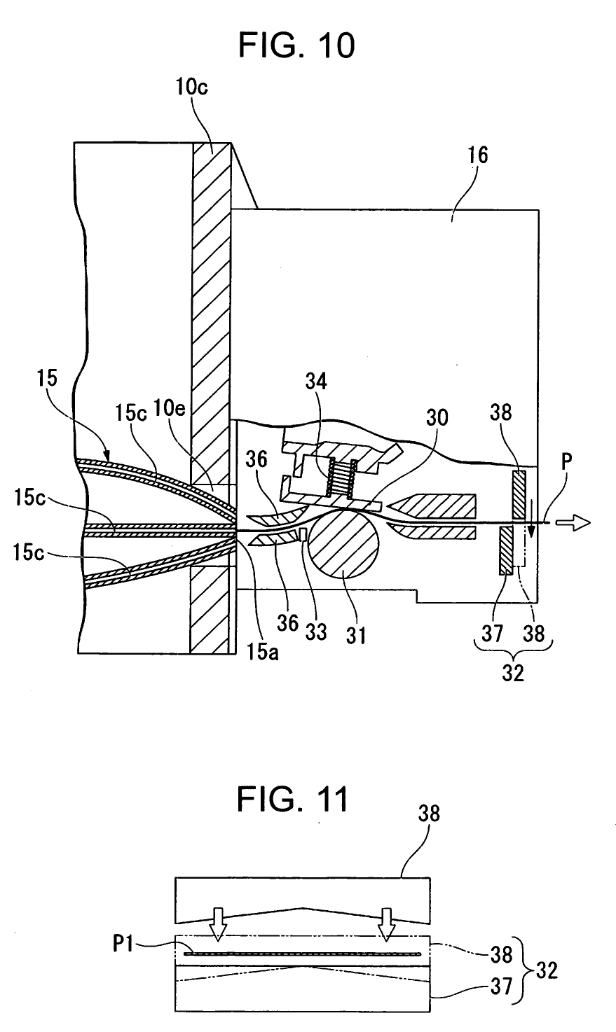

As illustrated in FIG. 10, the above-mentioned printing unit 16 is fixed to the front panel 10c on the side opposite to the side on which the guide member 15 is disposed. The printing unit 16 includes a thermal head 30, a platen roller 31, a cutting member 32, and a sensor 33.

The thermal head 30 is disposed, while sandwiching the front panel 10c therebetween, so as to be adjacent with respect to the carry-out port 15a of the guide member 15. In this case, the thermal head 30 is disposed so that the longitudinal direction thereof is directed to the width directions of the recording sheets P1. Further, the thermal head 30 is a thermal head 30 capable of supporting the recording sheet P1 of 4-inch width at maximum, and has a large number (832 dots) of heating elements along the width direction of the recording sheet P1. The large number of heating elements are controlled so as to respectively generate heat based on the signal from the control portion 17. In this regard, detailed description is made later. The thermal head 30 structured as described above is in the state of being biased by an elastic member 34 such as a coil spring to the side of the platen roller 31.

The platen roller 31 is disposed oppositely with respect to the thermal head 30 in the state of sandwiching therebetween the recording sheet P1 guided by the guide member 15 so that the outer peripheral surface thereof comes into contact with the thermal head 30. The platen roller 31 includes, similarly to the conveyor roller 14a, a driven gear (not shown) fixed at one end thereof, the driven gear being engaged with a gear transmission mechanism (not shown) rotated by a motor 35 (stepping motor, for example) illustrated in FIG. 2. With this structure, the platen roller 31 is rotated by the rotatably driving force from the motor 35, so the recording sheet P1 can be drawn out to the side of the printing unit 16 or drawn back to the side of the guide member 15. Note that the motor 35 is, similarly to the motor 14c for driving the conveyor roller 14a, forward-reverse rotated by receiving the signal of the control portion 17.

Further, between the platen roller 31 and the carry-out port 15a of the guide member 15, guide plates 36 are disposed for guiding the carried-out recording sheets P1 to the platen roller 31. Further, between the guide plates 36 and the platen roller 31, a sensor 33 is disposed for detecting whether the recording sheets P1 guided by the guide member 15 have reached the platen roller 31. The sensor 33 is, for example, an optical sensor for detecting the presence and absence of the recording sheets P1 by the reflection of light, and outputs the detection result to the control portion 17.

Further, adjacent to the platen roller 31, a fixed blade 37 and a movable blade 38 are provided for cutting the recording sheets P1 having passed the thermal head 30. The movable blade 38 is slid along the fixed blade 37 by the motor (not shown) controlled by the control portion 17. In particular, as illustrated in FIG. 11, the movable blade 38 is cut in a V-shaped configuration so as to recess the center thereof with respect to the ends thereof. Thus, when cutting the recording sheets P1, the recording sheets P1 are gradually cut from the ends toward the centers.

Those fixed blade 37 and movable blade 38 function as the cutting member 32 for cutting the recording sheets P1 having passed the thermal head 30.

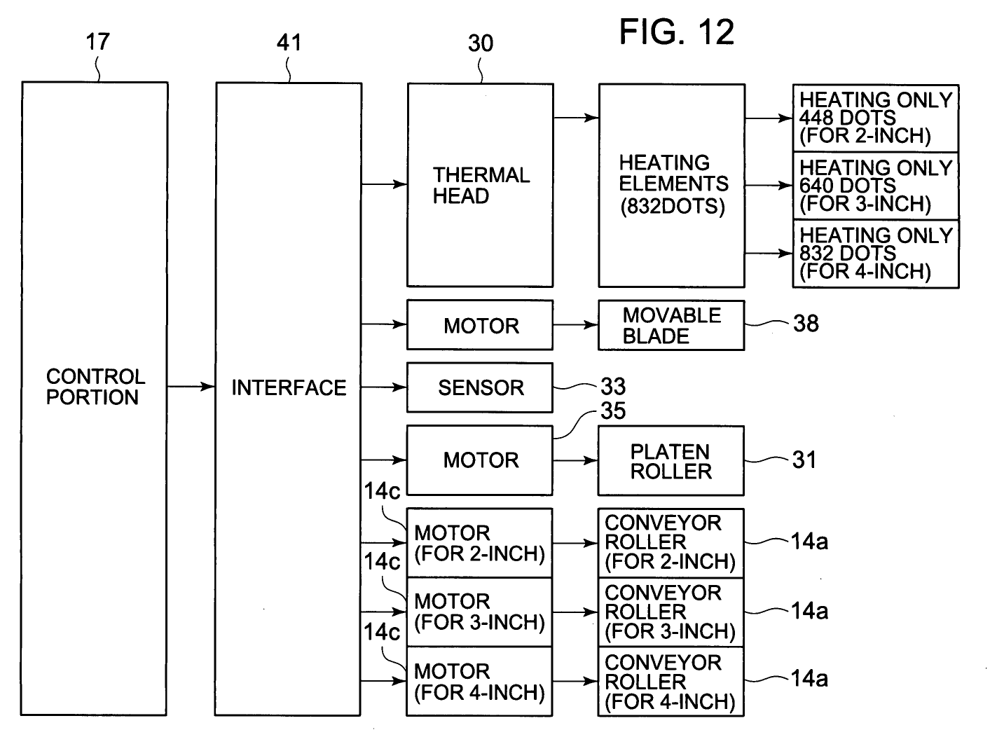

Further, on the bottom portion panel 10a of the casing 10, as illustrated in FIG. 2, there is attached a control substrate 40 mounted with the electronic devices of various types and the control portion 17. The control portion 17 is connected, as illustrated in FIG. 12, to each of the components via an interface 41, and selects any of the roll sheets P of three types in accordance with the instruction input to the operation panel 3, so each of the components is comprehensively controlled so as to perform printing only on the recording sheet P1 wound in the selected roll sheet P.

Specifically, the control portion 17 controls, based on the detection result from the sensor 33, rotational directions of the conveyor roller 14a and the platen roller 31 so as to send out, from the guide member 15 to the side of the platen roller 31, only the recording sheet P1 wound in the roll sheet selected from the roll sheets P. Further, simultaneously therewith, the control portion 17 controls each of the components so as to perform printing while activating the heating elements of the thermal head 30, the number of which corresponds to the width of the sent-out recording sheet P1.

For example, in the case of the recording sheet P1 of 2-inch width, printing is performed by heating the heating elements of the number corresponding to 2-inch width out of the heating elements of 832 dots, that is, the heating elements of 448 dots. Further, in the case of the recording sheet P1 of 3-inch width, printing is performed by heating the heating elements of the number corresponding to 3-inch width out of the heating elements of 832 dots, that is, the heating elements of 640 dots. Further, in the case of the recording sheet P1 of 4-inch width, printing is performed by heating the heating elements of the number corresponding to 4-inch width out of the heating elements of 832 dots, that is, all the heating elements of 832 dots.

Next, there is described the case where the thermal printer 1 structured as described above is activated. First, it is assumed that, as illustrated in FIGS. 2 to 5, the three roll sheets P of 2-inch width, 3-inch width, and 4-inch width are sequentially set by default on the rotational axis portions 13b from the side of the front panel 10c of the casing 10. Further, as illustrated in FIG. 7, the recording sheet P1 of each of the roll sheets P enters, after passing between the conveyor roller 14a and the holding plate 14b, the guide member 15 so as to be led to the carry-out port 15a, thereby being in a standby state.

Here, when the user operates the operation panel 3 illustrated in FIG. 1 at the time of using the account machine or the ticket-vending machine, the control portion 17 selects, in accordance with the operational purpose and the information amount to be printed, printing on any of the roll sheets P of three types. Further, the control portion 17 controls each of the components so as to send only the recording sheet P1 wound in the selected roll sheet P to the side of the platen roller 31, whereby printing is performed on the recording sheet P1. In this embodiment, first, there is described the case where the control portion 17 selects the roll sheet P of 2-inch width so as to perform printing on the recording sheet P1 wound in the roll sheet P.

That is, the control portion 17 activates the motor 14c by sending a signal to the motor 14c of each of the conveyor mechanisms 14 corresponding to the selected roll sheet P of 2-inch width. Then, the conveyor roller 14a is rotated by receiving the rotational driving force of the motor 14c, so the recording sheet P1 wound in the roll sheet P of 2-inch width is sent out from the carry-out port 15a of the guide member 15 to the side of the platen roller 31. The recording sheet P1 sent out from the carry-out port 15a reaches the platen roller 31 while guided by the guide plates 36. In this case, the recording sheet P1 enters the state of covering the sensor 33. Accordingly, the sensor 33 detects that the sent-out recording sheet P1 has reached the platen roller 31, and then provides an output to the control portion 17.

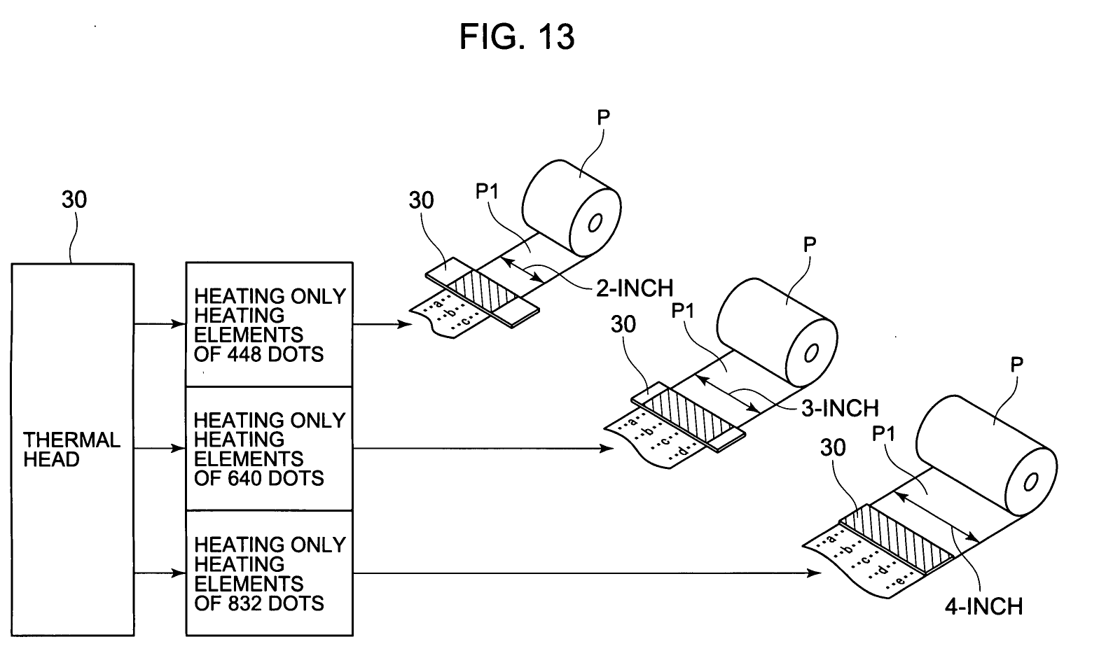

Then, the control portion 17 outputs, by receiving the detection result from the sensor 33, an signal to the motor 35 so as to activate the platen roller 31 in addition to the conveyor roller 14a. As a result, the recording sheet P1 is sent out in the state of being sandwiched between the outer peripheral surface of the platen roller 31 and the thermal head 30. Further, simultaneously therewith, as illustrated in FIG. 13, the control portion 17 activates the heating elements of the thermal head 30, the number of which corresponds to the width of the sent-out recording sheet P1, that is, to the length (2-inch) of the width of the selected roll sheet P. That is, the heating elements of 448 dots are activated. As a result, the heating elements of 448 dots corresponding to the width of the recording sheet P1 generate heat, so the letters of and figures various types can be clearly printed with respect to the sent-out recording sheet P1.

After that, the printed recording sheet P1 is sent out toward the front surface of the printing unit 16. Accordingly, the printed recording sheet P1 starts to be discharged, as illustrated in FIG. 1, from the discharge port 2a of the box body 2 to the outside. Further, the control portion 17 outputs a signal to the motor so as to activate the movable blade 38 at the timing the printed portion is completely discharged from the discharge port 2a. Accordingly, the movable blade 38 slides along the fixed blade 37, so the recording sheet P1 is cut. As a result, the recording sheet P1 wound in the selected roll sheet P of 2-inch width is received by the user as a receipt, a ticket, or the like.

Next, there is described the case where the control portion 17 selects, as a result of the operation of the operational panel 3 conducted by a user, the roll sheet P of 3-inch width, which has different width than that in the previous case, so as to perform printing on the roll sheet P.

In this case, first, the control portion 17 outputs a signal to each of the motors 14c and 35 so as to reverse-rotate the conveyor roller 14a of each of the conveyor mechanisms 14 corresponding to the roll sheet P of 2-inch width and the platen roller 31. As a result, the recording sheet P1 sandwiched between the platen roller 31 and the thermal head 30 can be drawn back. In this case, the recording sheet P1 moves from the side of the platen roller 31 toward the carry-out port 15a of the guide member 15, and thus is separated from the platen roller 31. Then, the sensor 33 detects that the recording sheet P1 has been separated from the platen roller 31, and notifies the control portion 17. In response thereto, the control portion 17 outputs a signal to the motor 35 so as to stop the rotation of the platen roller 31, and activates the motor 14c so as to continuously rotate only the conveyor roller 14a for a predetermined time. As a result, the recording sheet P1 of 2-inch width previously subjected to printing can be drawn back from the carry-out port 15a to the inside of the guide member 15.

At this point in time, preparation is completed for drawing out the recording sheet P1 wound in the roll sheet P of 3-inch width. Subsequently, the control portion 17 outputs a signal to the motor 14c so as to rotate the conveyor roll of each of the conveyor mechanisms 14 corresponding to 3-inch width newly selected. As a result, the recording sheet P1 of 3-inch width await at the carry-out port 15a of the guide member 15 is sent out from the carry-out port 15a to the side of the platen roller 31. Further, when the recording sheet P1 enters the state of having reached the platen roller 31 to cover the upper side of the sensor 33, the sensor 33 outputs to the control portion 17 that the recording sheet P1 has reached the platen roller 31. The control portion 17 outputs, upon reception of the detection result, the signal to the motor 35 so as to rotate the platen roller 31 in addition to the conveyor roller 14a.

Subsequently, the control portion 17 performs the control similar to that on the recording sheet P1 of 2-inch width subjected to printing first. As a result, it is possible to perform printing on the recording sheet P1 of 3-inch width newly selected. In this case, as illustrated in FIG. 13, the control portion 17 activates the heating elements of the thermal head 30, the number of which corresponds to the length of the recording sheet P1 of 3-inch width newly selected. That is, the heating elements of 640 dots are activated. Accordingly, the letters and figures of various types can be clearly printed over the entire recording sheet P1 of 3-inch width without involving extra margins or the like.

Further, in the case where the control portion 17 selects the roll sheet P of 4-inch width so as to perform printing on the roll sheet P as a result of the operation of the operational panel 3 conducted by a user, the same operation as that on the above-mentioned roll sheet P of 3-inch width is repeatedly conducted. Note that, as illustrated in FIG. 13, the control portion 17 activates the heating elements of the thermal head 30, the number of which corresponds to the length of the selected recording sheet P1 of 4-inch width. That is, all the heating elements of 832 dots are activated. Accordingly, the letters and figures of various types can be clearly printed over the entire recording sheet P1 of 4-inch width without involving extra margins or the like.

As described above, in the thermal printer 1 of this embodiment, the roll sheets P each having a different width can be simultaneously dealt with, and it is possible to perform clear printing with respect to, without involving extra margins or the like, the recording sheets P1 each having a different width and wound in each of the roll sheets p.

In particular, unlike the conventional cases, it is unnecessary to prepare the thermal printers 1 of the same number as that of the roll sheets P each having a different width, so large reduction in cost can be achieved, which leads to alleviation of the burden on the user and alleviation of the burden on the user. Further, the installation space therefor can be largely reduced, which leads to the ease with which the thermal printer 1 is dealt with. Further, since the roll sheets P each having a different size can be simultaneously used, the functionality as a printer can be increased, thereby achieving increase in performance.

Further, since the roll sheets P of three types are aligned in the single direction in the state where the center lines L in the width directions coincide with one another, when cutting each of the recording sheets P1, the recording sheet P1 can be similarly cut from the ends toward the center by the movable blade 38. Thus, the cutting conditions can be conformed to each other, so the quality of the recording sheets P1 after printing can be increased. In particular, since the recording sheet P1 is cut from the ends toward the center, the posture of the recording sheet P1 is less liable to change. Thus, the wrinkles and the like are not generated, so the recording sheet P1 can be cleanly cut.

Still further, since the recording sheet P1 wound in each of the roll sheets P of three types is drawn out in a substantially horizontal manner, the recording sheets P1 are less liable to be drawn out and drawn back on its own by the influence of gravity. Thus, owing to the conveyor roller 14a and the platen roller 31, taking-out and putting-in of the recording sheets P1 is easy to control, with the result that the reliability in activation thereof can be increased.

In addition, since the recording sheet P1 is sandwiched between the holding plate 14b and the conveyor roller 14a, the rotation of the conveyor roller 14a can be transmitted to the recording sheet P1 more efficiently. In this regard also, drawing-out and drawing-back of the recording sheet P1 can be performed more smoothly, so the reliability in activation thereof can be further increased.

Note that, the technical scope of the present invention is not limited to the above-mentioned embodiment, but various modifications can be made without departing from the spirit of the present invention.

For example, in the above-mentioned embodiment, there is exemplified the case where the roll sheets of three types of 2-inch width, 3-inch width, and 4-inch width are set. However, the present invention is not limited to the case, and the width of the roll sheet P and the number of roll sheets P may be freely set.

Further, the support member 13 supports the roll sheets P of three types at different heights so that the recording sheets P1 are drawn out in a substantially horizontal manner. However, the recording sheets P1 may be supported so as to be obliquely drawn out with respect to the horizontal surface.

Further, the roll sheets P of three types are supported while aligned in a single direction in the state where the center lines L in the width directions coincide with one another. However, the roll sheets P may be supported so that one side surface of each of the roll sheets P coincide with one another. Note that, as in the above-mentioned embodiment, it is preferable that the roll sheets P of three types be supported so as to coincide the center lines L in the width directions with one another because the recording sheet P1 can be cut from the ends toward the center.

What is claimed is:

1. A thermal printer in which a plurality of roll sheets each having a different width and each being obtained by winding a recording sheet into a roll are set, for performing printing on the recording sheet drawn out of the desired roll sheet, comprising:
a support member for rotatably supporting the plurality of roll sheets each having the different width;
conveyor mechanisms disposed in a number corresponding to a number of the plurality of roll sheets and each including a forward-reverse rotatable conveyor roller for drawing out or drawing back the recording sheet wound in each of the roll sheets;
a guide member for guiding the recording sheet drawn out of each of the plurality of roll sheets so as to be converged on a carry-out port;
a thermal head disposed adjacent to the carry-out port of the guide member and including multiple heating elements aligned in a width direction of the recording sheet;
a forward-reverse rotatable platen roller disposed oppositely to the thermal head and having an outer peripheral surface coming into contact with the thermal head in a state where the recording sheet guided by the guide member is sandwiched therebetween;
a cutting member for cutting the recording sheet having passed the thermal head;
a sensor disposed between the guide member and the platen roller, for detecting whether or not the recording sheet guided by the guide member has reached the platen roller; and
a control portion for controlling, based on a detection result from the sensor, rotational directions of the conveyor roller and the platen roller so that only a recording sheet wound in the roll sheet selected from the plurality of roll sheets is sent out from the guide member to a side of the platen roller, and controlling so that printing is performed while activating the heating elements corresponding to a width of the sent-out recording sheet.

2. A thermal printer according to claim 1, wherein the support member supports the plurality of roll sheets in a state where the plurality of roll sheets are aligned in a single direction with center lines thereof in a width direction coinciding with one another.

3. A thermal printer according to claim 2, wherein the support member supports the plurality of roll sheets in a state where the plurality of roll sheets are disposed at different heights so that the recording sheet to be drawn out of each of the plurality of roll sheets reaches the guide member after being drawn out in a substantially horizontal manner.

4. A thermal printer according to claim 1, wherein the conveyor mechanisms each comprise a holding plate disposed oppositely to the conveyor roller, for sandwiching, with an aid of the conveyor roller, the recording sheet therebetween.

5. A thermal printer according to claim 1, wherein the support member supports, as the plurality of roll sheets, three roll sheets of 2-inch width, 3-inch width, and 4-inch width.
